(19) United States
(12) Patent Application Publication
(10) Pub. No.: US 2018/0202925 A1
(43) Pub. Date: Jul. 19, 2018

(54) SENSOR

(71) Applicant: Panasonic Intellectual Property Management Co. Ltd., Osaka (JP)

(72) Inventors: SHINICHI KISHIMOTO, Osaka (JP); MASAHIKO OHBAYASHI, Osaka (JP); KOJI SAKAI, Hyogo (JP)

(21) Appl. No.: 15/748,847

(22) PCT Filed: Sep. 30, 2016
(86) PCT No.: PCT/JP2016/004412

§ 371 Date: Jan. 30, 2018

(30) Foreign Application Priority Data
Oct. 7, 2015 (JP) 2015-199294
Nov. 9, 2015 (JP) 2015-219122

(51) Int. Cl. G01N 21/3577; G01N 21/3504; G01N 21/03; G01N 21/31; G01J 3/10; G01N 29/036; G01N 21/05; G01J 3/42

(52) U.S. Cl. CPC G01N 21/3577; G01N 21/3504; G01N 21/0303; G01N 21/314; G01J 2005/068; G01N 29/036; G01N 21/05; G01J 3/42; G01J 3/108

(57) ABSTRACT

A sensor includes a body having an internal space allowing fluid to flow into the internal space, a light-emitting device that emits light passing through; first and second light-receiving devices that receive the light that has passed through the internal space, a first optical filter disposed between the first light-receiving device and the light-emitting device and configured to pass the light therethrough, a second optical filter disposed between the second light-receiving device and the light-emitting device and configured to pass the light therethrough, and a controller. The controller is configured to change the light emitted from the light-emitting device, and to compare a ratio between first and second outputs before the change of the light to a ratio between the first and second outputs after the change of the light.

### TECHNICAL FIELD

The present invention relates to a sensor for detecting a concentration of an object in fluid by using an absorbing characteristic of light, such as infrared ray.

### BACKGROUND ART

PTL 1 discloses a conventional sensor that receives light emitted from a light-emitting device with a light-receiving device, and detects a concentration of fluid based on a transmittance of the received light.

PTL 2 discloses a conventional sensor including a tube into which a gas is introduced, a light source that applies light into the tube, a first detection device disposed in the tube, a second detection device disposed in the tube, and a temperature sensor that measures an ambient temperature. The first detection device outputs a value in accordance with the optical amount of light having a wavelength that is not absorbed by a particular gas. The second detection device outputs a value in accordance with the optical amount of light having a wavelength that is absorbed by the particular gas. In this sensor, in accordance with a reference output of the first detection device that has previously acquired an output of the first detection device, the second detection device performs similar correction, thereby canceling the influence of a temperature change and deterioration with time.

PTL 3 discloses a conventional sensor that includes an infrared light source and an infrared light-receiving part. This sensor measures the optical amount of infrared rays that have passed through fluid, and detects a concentration of fluid. In this sensor, a heater pattern is disposed in a gas distribution part.

### CITATION LIST

### Patent Literatures

PTL 1: Japanese Patent Laid-Open Publication No. 2010-145252
PTL 2: Japanese Patent Laid-Open Publication No. 2014-074629
PTL 3: Japanese Patent Laid-Open Publication No. 2012-177690

### SUMMARY

A sensor includes a body having an internal space allowing fluid to flow into the internal space, a light-emitting device that emits light passing through the internal space, first and second light-receiving devices that receive the light that has passed through the internal space, a first optical filter disposed between the first light-receiving device and the light-emitting device and allowing the light to pass through, a second optical filter disposed between the second light-receiving device and the light-emitting device and allowing the light to pass through, and a controller. The controller is configured to change the light emitted from the light-emitting device, and to compare a ratio between first and second outputs before the change of the light to a ratio between the first and second outputs after the change of the light.

Another sensor includes the body, the light-emitting device, the first and second light-receiving devices, the first and second optical filters, and a controller. The controller is configured to change light emitted from the light-emitting device when the sensor starts up.

The sensor can accurately detect a failure in the light-receiving devices independently of the concentration of the fluid.

### BRIEF DESCRIPTION OF DRAWINGS

FIG. 1 is a side cross-sectional view of a sensor according to Exemplary Embodiment 1.

FIG. 2 is a block diagram of the sensor according to Embodiment 1.

FIG. 3 shows a voltage applied to a light-emitting device of the sensor according to Embodiment 1.

FIG. 4 shows a light emission spectrum of the sensor according to Embodiment 1.

FIG. 5 shows another voltage applied to the light-emitting device of the sensor according to Embodiment 1.

FIG. 6 is a block diagram of a sensor according to Exemplary Embodiment 2.

FIG. 7A shows a voltage applied to a light-emitting device of the sensor according to Embodiment 2.

FIG. 7B shows a light emission spectrum of the sensor according to Embodiment 2.

FIG. 8 is a side cross-sectional view of a sensor according to Exemplary Embodiment 3.

FIG. 9A is an enlarged cross-sectional view of a window of the sensor according to Embodiment 3.

FIG. 9B is an enlarged cross-sectional view of another window of the sensor according to Embodiment 3.

FIG. 9C is an enlarged cross-sectional view of an optical filter of the sensor according to Embodiment 3.

FIG. 9D is an enlarged cross-sectional view of another optical filter of the sensor according to Embodiment 3.

FIG. 10 is a side cross-sectional view of a sensor according to Exemplary Embodiment 4.

FIG. 11A is a front view of a window of the sensor according to Embodiment 4.

FIG. 11B illustrates vibrations of the window illustrated in FIG. 11A.

FIG. 12 is a side cross-sectional view of another sensor according to Embodiment 4.

FIG. 13 is a side cross-sectional view of a sensor according to Exemplary Embodiment 5.

### DETAIL DESCRIPTION OF EXEMPLARY EMBODIMENTS

Sensors according to exemplary embodiments will be hereinafter described with reference to the drawings. In the drawings, the same or like components are denoted by the same reference characters, and description thereof will not be repeated. Components of the exemplary embodiments may be combined in any manner within the range where no contradiction occurs.

### Exemplary Embodiment 1

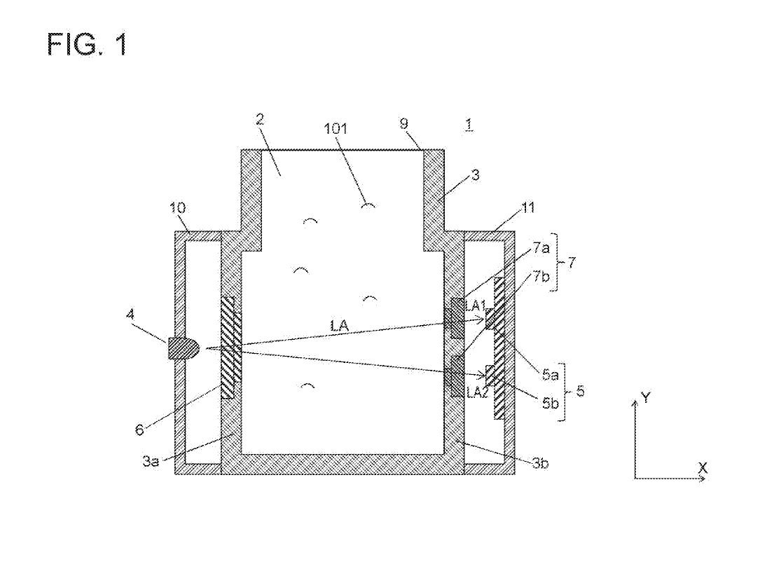

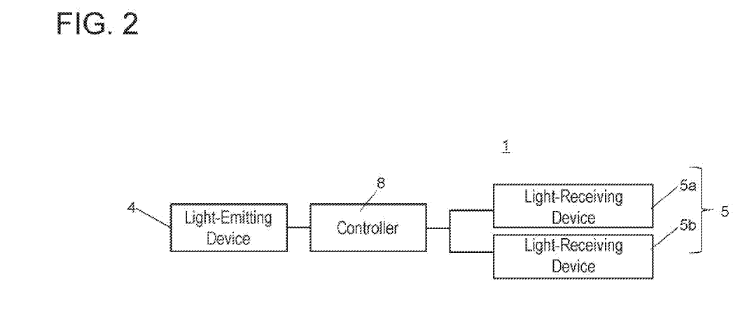

FIG. 1 is a side cross-sectional view of sensor 1 according to Exemplary Embodiment 1. FIG. 2 is a block diagram of sensor 1. Sensor 1 includes body 3, light-emitting device 4 that emits light LA, light-receiving device 5 that receives light LA, optical filter 7, and controller 8 that controls light LA emitted from the light-emitting device 4. Body 3 has internal space 2 therein allowing fluid 101 as an object to flow in the space. Body 3 includes window 6. In accordance with Embodiment 1, fluid 101 is butane. Window 6 is made of light-transmitting material that transmits light LA through it.

In FIG. 1, an X axis and a Y axis perpendicular to each other are defined. Body 3 is made of resin having high heat resistance and high chemical resistance, and has a rectangular parallelepiped shape. The body has side walls 3a and 3b disposed at positive and negative directions on the X axis respectively. Body 3 has opening 9 that is open in the positive direction on the Y axis. The cross-sectional area of body 3 along the X axis is locally small near opening 9. Side wall 3b of body 3 in the negative direction of the X axis has window 6. Side wall 3a of body 3 located in the positive direction of the X axis is provided with optical filter 7. Block 10 is disposed outside body 3 in the negative direction of the X axis. Block 11 is disposed outside body 3 in the positive direction of the X axis. Block 10 is provided with light-emitting device 4. Block 11 is provided with light-receiving device 5. Light LA emitted from light-emitting device 4 enters internal space 2 of body 3 from window 6, and passes through internal space 2. Light LA that has passed through internal space 2 enters light-receiving device 5 through optical filter 7. Light-receiving device 5 includes light-receiving devices 5a and 5b. Optical filter 7 includes optical filters 7a and 7b. Light LA1 that has passed through optical filter 7a enters light-receiving device 5a. Light LA2 that has passed through optical filter 7b enters light-receiving device 5b. Light transmitted through optical filter 7a has a wavelength different from light transmitted through optical filter 7b. Thus, light-receiving devices 5a and 5b provide different outputs in response to light LA. The shape of opening 9 of body 3 is not necessarily the rectangular parallelepiped shape, and the cross-sectional area of body 3 does not necessarily be locally small near opening 9. Body 3 may have another shape, such as a cylindrical shape having a uniform cross-sectional area. The material of body 3 is not necessarily resin, and may be appropriately selected depending on operating environments.

In sensor 1, light-emitting device 4 and light-receiving device 5 are disposed to locate internal space 2 between light-emitting device 4 and light-receiving device 5. However, the invention is not limited to this configuration. Sensor 1 may further include a mirror disposed in internal space 2 in the positive direction of the X axis. In this case, light-emitting device 4 and light-receiving device 5 are disposed in the negative direction of the X axis from internal space 2. In this configuration, light LA emitted from light-emitting device 4 running in the positive direction of the X axis is reflected on the mirror to run in the negative direction of the X axis, and enters to light-receiving device 5. This configuration reduces the size of sensor 1.

Opening 9 of body 3 is connected to a block for introducing fluid 101. Fluid 101 is introduced from this block. Light LA emitted from light-emitting device 4 passes through internal space 2 and enters to light-receiving device 5. While light LA passes through fluid 101, light LA is absorbed by fluid 101. The absorption of light LA in fluid 101 reduces the intensity of light received by light-receiving device 5. Controller 8 processes an output signal from light-receiving device 5 in accordance with the intensity of received light so as to detect a concentration of fluid 101 in internal space 2. Since body 3 includes window 6 and optical filter 7, light-emitting device 4 and light-receiving device 5 do not directly contact fluid 101, hence avoiding contamination with particles contained in fluid 101. In addition, fluid 101 (butane), which is flammable fluid cannot light-emitting device 4 that generates heat.

In accordance with Embodiment 1, light LA emitted from light-emitting device 4 has a wavelength ranging from 1.4 μm to 5.7 μm. Light LA having a wavelength in this range is absorbed by butane, and sensor 1 can detect the concentration of butane. Since sensor 1 employs butane as fluid 101, which is an object, the wavelength of light LA ranges from 1.4 μm to 5.7 μm. Alternatively, the wavelength of light LA may be appropriately changed depending on the detection target. Light-emitting device 4 is pulse-driven. Controller 8 applies voltage V4 having a pulse waveform with predetermined frequency f4 to light-emitting device 4 so that light-emitting device 4 emits light LA. In accordance with Embodiment 1, voltage V4 is 5 V, and frequency f4 is 10 Hz. The values of frequency f4 and voltage V4 can be appropriately changed depending on operating conditions. The values of frequency f4 and voltage V4 are controlled by controller 8.

Light-receiving devices 5a and 5b are implemented by pyroelectric sensors or thermocouples, receive light LA, and output signals in accordance with the intensity of received light. Controller 8 measures amplitudes of these signals so that light-receiving devices 5a and 5b calculate the intensities of received light. Light-receiving device 5 employs pyroelectric sensors or thermocouples. Materials of light-receiving devices 5a and 5b may be appropriately selected in accordance with the wavelength of light LA.

Optical filter 7a allows only light having a wavelength absorbed by fluid 101 as an object to pass through. Optical filter 7b does not allow light having a wavelength absorbed by fluid 101 to pass through in light LA emitted from light-emitting device 4. In accordance with Embodiment 1, in light LA emitted from light-emitting device 4, optical filter 7b allows only light having a wavelength not being absorbed by fluid 101 but passing through fluid 101 to pass through. In accordance with Embodiment 1, optical filter 7a allows only light having wavelength λa to pass through. Optical filter 7b allows only light having wavelength λb to pass through. In accordance with Embodiment 1, wavelength λa passing through optical filter 7a is 3.4 μm, and wavelength λb passing through optical filter 7b is 4.0 μm. Controller 8 compares output signals from light-receiving devices 5a and 5b to accurately detect a concentration of fluid 101 as an object.

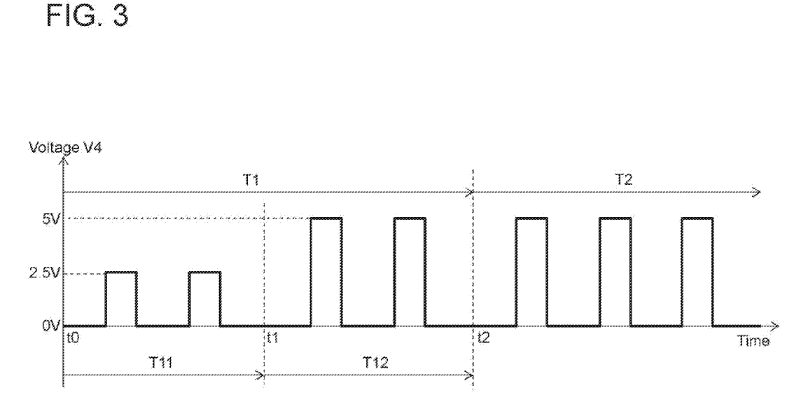

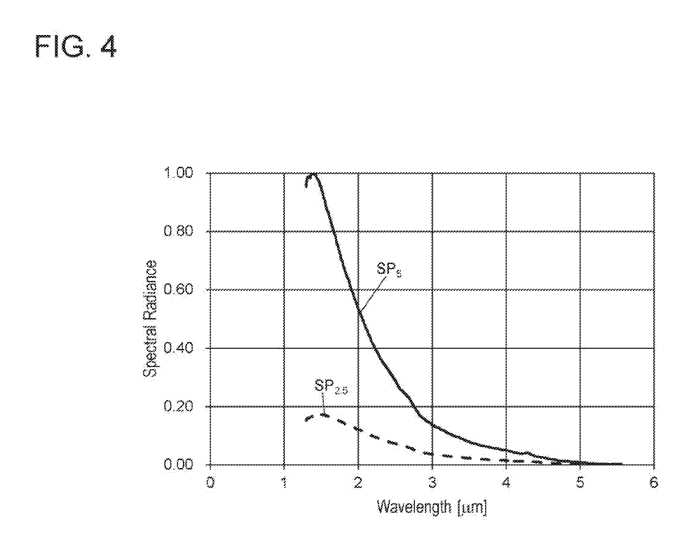

FIG. 3 shows voltage V4 applied to light-emitting device 4 when sensor 1 starts up. FIG. 4 shows emission spectrum SP₅ of light LA emitted from light-emitting device 4 to which voltage V4 of 5 V is applied and emission spectrum SP_{2.5} of light LA emitted from light-emitting device 4 to which voltage V4 of 2.5 V is applied. FIG. 4 shows emission spectra SP₅ and SP_{2.5} normalized by assuming, as 1 (one), the maximum spectral radiance of light LA emitted from light-emitting device 4 to which voltage V4 having a value of 5 V is applied.

When light-receiving device 5 is normal, as output W₁ of light-receiving device 5a and output W₂ of light-receiving device 5b, signals of values corresponding to the intensities of light LA1 and light LA2 that have reached light-receiving devices 5a and 5b among values indicated by, for example, emission spectrum SP₅ of light-emitting device 4 are output. However, if light-receiving device 5 is broken, output W₁ or output W₂ is not a normal value any more, and thus, the concentration of fluid 101 cannot be accurately detected. A failure of light-receiving device 5 can be determined by comparing an output of light-receiving device 5 at start-up of sensor 1 with an output of light-receiving device 5 while sensor 1 does not start. However, since an output of light-receiving device 5a changes depending on the concentration of fluid 101 in body 3, it is difficult to accurately determine whether a failure of light-receiving device 5 occurs or not.

For example, in the conventional sensors described in PTLs 1, 2, and 3, a failure in a light-receiving device cannot be accurately determined, resulting in a decrease of accuracy in detecting a concentration of fluid.

Sensor 1 according to the embodiment can determine a failure more accurately than the conventional sensors by detecting ratio R₁ (=W₁/W₂) of output W₁ to output W₂ (ratio R₁ of output W₁ to output W₂ in accordance with Embodiment 1). An operation of sensor 1 will be described below with reference to FIGS. 3 and 4.

Sensor 1 starts up at time point t0. Immediately after the start-up of sensor 1, self-determination measurement is performed in self-determination period T1, and then, normal measurement starts at time point t2 so that normal measurement is performed in normal measurement period T2. In the self-determination measurement in self-determination period T1, controller 8 determines a failure in light-receiving device 5 by changing voltage V4 applied to light-emitting device 4. If controller 8 determines that a failure occurs in light-receiving device 5, controller 8 issues a warning of the failure to a user of sensor 1. The value of voltage V4 of light-emitting device 4 is 5 V in normal measurement by sensor 1, and is changed to values 2.5 V and 5 V in the self-determination measurement.

In sensor 1, controller 8 sets the value of voltage V4 of light-emitting device 4 at 2.5 V at time point t0 when sensor 1 starts up, and drives light-emitting device 4 in predetermined period T11 to measure outputs W₁ and W₂ of light-receiving devices 5a and 5b. Controller then at time point t1 changes the value of voltage V4 to 5 V to measure outputs W₁ and W₂ of light-receiving devices 5a and 5b in predetermined period T12. As illustrated in FIG. 4, ratio R₂ (=W₃/W₄) of spectral radiance W₃ at wavelength λa (=3.4 μm) of light LA to spectral radiance W₄ at wavelength λb (=4.0 μm) (ratio R₂ of spectral radiance W₃ to spectral radiance W₄ in accordance with Embodiment 1) is about 1.81 when the value of voltage V4 is 5 V. Ratio R₂ is about 1.70 when the value of voltage V4 is 2.5 V. Controller 8 may previously store ratio R₂ of spectral radiance W₃ to spectral radiance W₄ (=W₃/W₄). In this case, after the starting up of sensor 1, controller 8 changes the value of voltage V4 of light-emitting device 4 from 2.5 V to 5 V, and detects output W₁ of light-receiving device 5a and output W₂ of light-receiving device 5b at the values of voltage V4, thereby detecting ratio R₁ (=W₁/W₂). Ratio R₁ (=W₁/W₂) are compared with ratio R₂ (W₃/W₄) at each of the values of 2.5 V and 5 V of voltage V4. If light-receiving device 5, that is, at least one of light-receiving devices 5a and 5b, is broken, ratio R₁ (=W₁/W₂) is significantly different from ratio R₂ (=W₃/W₄) at each value of voltage V4. Thus, controller 8 detects ratios R₁ (=W₁/W₂) before and after the change of voltage V4, and compares each of detected ratios R₁ with ratio R₂ (=W₃/W₄), thereby determining whether light-receiving device 5 is broken or not.

If light-receiving device 5 is broken, deviations of output W₁ and output W₂ from the emission spectrum change depending on voltage V4. For example, if light-receiving device 5a is broken, output W₁ for voltage V4 of 5 V is 0.1×W₃ and output W₁ for voltage V4 of 2.5 V is 0.2×W₃. When the value of voltage V4 is 5 V, output W₁ is about 10% of spectral radiance W₃. When a light source voltage is 2.5 V, output W₁ is about 20% of spectral radiance W₃. A difference of about 10% occurs in output W₁ between the light source voltage of 2.5 V and 5 V. That is, when the voltage V4 changes, a ratio between output W₁ and spectral radiance W₃ changes. Thus, when the value of voltage V4 of light-emitting device 4 changes from 2.5 V to 5 V, a ratio between ratio R₁ (=W₁/W₂) and ratio R₂ (=W₃/W₄) also changes. Accordingly, if the ratio between ratio R₁ and ratio R₂ changes when voltage V4 changes, controller 8 can determine that light-receiving device 5 is broken. That is, controller 8 compares ratio R₁ (=W₁/W₂) for voltage V4 of light-emitting device 4 of 2.5 V with ratio R₁ (=W₁/W₂) for voltage V4 of 5 V. If ratio R₁ has significantly changed, it can be determined that light-receiving device 5 is broken. Controller 8 thus detects a change of ratio R₁ (=W₁/W₂) for the values of voltage V4 of 5 V and 2.5 V, thereby accurately determining a failure of light-receiving device 5 independently of the concentration of fluid 101. As described above, by comparing the values of ratio R₁ (=W₁/W₂) before and after the change of voltage V4, controller 8 can determine that a failure occurs in light-receiving device 5, that is, at least one of light-receiving devices 5a and 5b, without recording spectral radiances W₃ and W₄.

Controller 8 can also determine which one of light-receiving device 5a or light-receiving device 5b is broken by comparing ratio R₁ (=W₁/W₂) with ratio R₂ (=W₃/W₄) to determine whether ratio R₁ is larger than ratio R₂ or not. In a case where light-receiving device 5a is broken, output W₁ is small, and thus, ratio R₁ (=W₁/W₂) is smaller than ratio R₂ (=W₃/W₄). In sensor 1 according to Embodiment 1, controller 8 determines that light-receiving device 5a is broken if ratio R₁ is smaller than ratio R₂ by a value equal to or larger than 10% of ratio R₂, and issues a warning to a user. In a case where light-receiving device 5b is broken, output W₂ is small, and thus, ratio R₁ (=W₁/W₂) is larger than ratio R₂ (=W₃/W₄). In sensor 1 according to Embodiment 1, if ratio R₁ is larger than ratio R₂ by a value equal to or larger than 10% of ratio R₂, controller 8 determines that light-receiving device 5b is broken, and issues a warning to the user.

A failure detection is thus performed at start-up of sensor 1. If light-receiving device 5 is broken, the warning is issued to the user to prevent the user from using sensor 1 in which light-receiving device 5 is broken. By performing the failure detection of changing the light source voltage of light-emitting device 4 during the use of sensor 1, the failure detection can also be performed during the use of sensor 1.

In addition, in determining degradation of light-receiving device 5, the value of voltage V4 is reduced to 2.5 V which is lower than a generally used value of 5 V, thus preventing light-emitting device 4 and light-receiving device 5 from being broken during the failure determination.

In accordance with Embodiment 1, optical filter 7a allows only light with a wavelength of 3.4 μm to pass through while optical filter 7b allows only light with a wavelength of 4.0 μm to pass through. However, the wavelength of light passing through the filters can be appropriately determined depending on fluid 101 as an object.

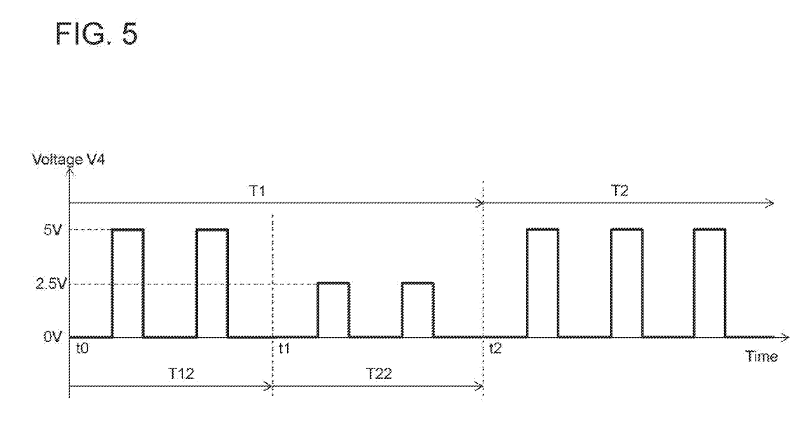

The values of voltage V4 are 5 V and 2.5 V, but may be appropriately determined depending on application conditions of sensor 1. In accordance with Embodiment 1, at start-up of sensor 1, the value of voltage V4 is initially set at 2.5 V, and then, after emission of light LA, the value is changed to 5 V. The value of voltage V4, however, is not necessarily changed in this order. FIG. 5 shows other values of voltage V4 of sensor 1. As shown in FIG. 5, after light LA is emitted when voltage V4 is an initial value of 5 V, the value of voltage V4 may be changed to 2.5 V, and then, changed to 5 V. In this case, a failure detection can also be performed.

In a case there ratio R₂ (W₃/W₄) deviates from ratio R₁ (=W₁/W₂) by a value equal to or larger than 10% of ratio R₂, the controller determines that a failure occurs in light-receiving device 5a or light-receiving device 5b, and issues a warning. However, the invention is not limited to this example. A criterion for issuing the warning may be appropriately changed depending on operating conditions of sensor 1. Controller 8 may correct output W₁ or W₂ when determining that a failure occurs in light-receiving device 5a or light-receiving device 5b.

Fluid 101 as a detection object in accordance with Embodiment 1 is butane, but may be other flammable gases, such as hydrocarbon. Sensor 1 according to Embodiment 1 can detect a concentration of gas (fluid 101), such as CO₂ or H₂O, that absorbs light.

### Exemplary Embodiment 2

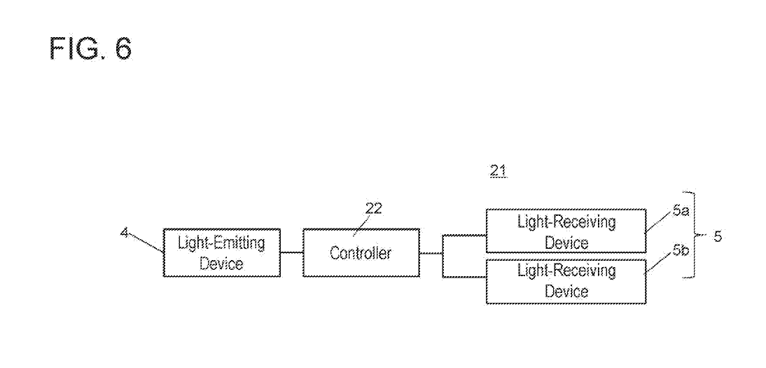

FIG. 6 is a block diagram of sensor 21 according to Exemplary Embodiment 2. In FIG. 6, components identical to those of sensor 1 according to Embodiment 1 illustrated in FIGS. 1 and 2 are denoted by the same reference numerals. Sensor 21 includes controller 22 connected to light-emitting device 4 and light-receiving device 5, instead of controller 8 of sensor 1 according to Embodiment 1.

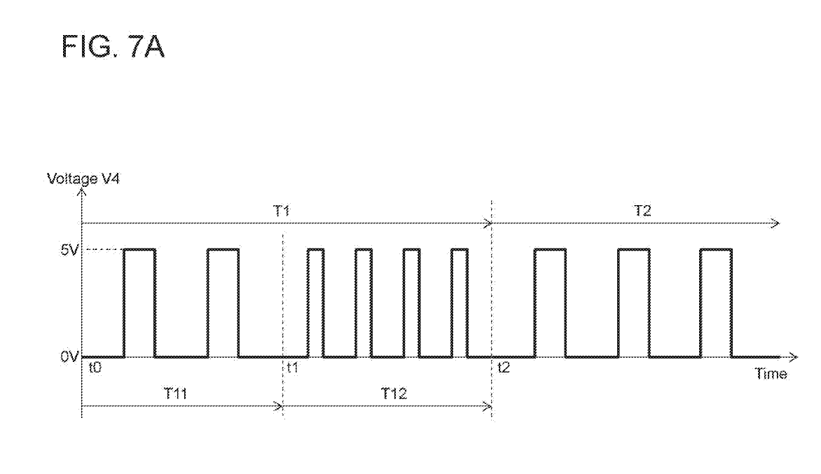

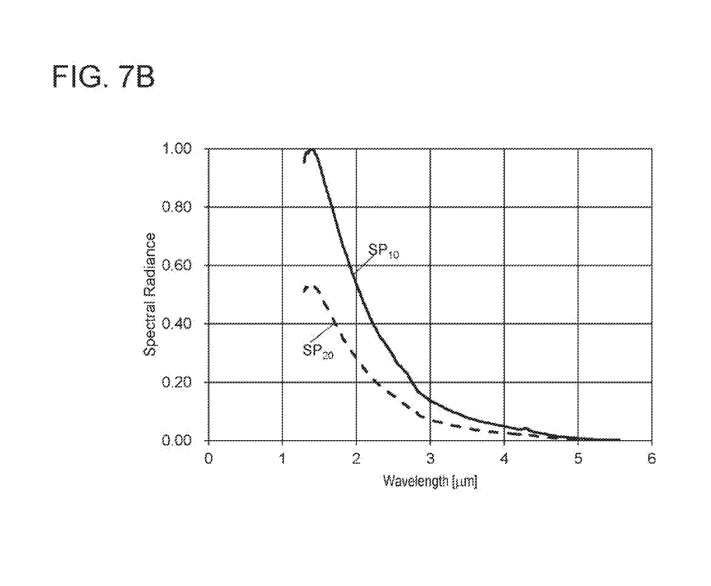

FIG. 7A shows voltage V4 applied to light-emitting device 4 by controller 22. Controller 22 of sensor 21 according to Embodiment 2 changes frequency f4 of voltage V4 in self-determination period T1 in order to determine a failure in light-receiving device 5. Controller 22 determines whether or not a failure occurs in light-receiving device 5 in self-determination period T1 to time point t2 from time point t0 when sensor 21 starts up. Controller 22 detects a concentration of fluid 101 in normal measurement period T2. In period T11 from time point t0 to time point t1 in self-determination period T1, controller 22 applies voltage V4 with frequency f4 of 10 Hz to light-emitting device 4. In period T12 from time point t1 to time point t2 in self-determination period T1, controller 22 applies voltage V4 with frequency f4 of 20 Hz to light-emitting device 4, and light-emitting device 4 emits light LA.

FIG. 7B shows the spectral radiance of light-emitting device 4 when frequency f4 of voltage V4 is changed, and shows emission spectrum SP₁₀ of light LA emitted from light-emitting device 4 to which voltage V4 with frequency f4 of 10 Hz is applied, and emission spectrum SP₂₀ of light LA emitted from light-emitting device 4 to which voltage V4 with frequency f4 of 20 Hz is applied. In FIG. 7B, the spectral radiance is normalized while assuming the maximum value when voltage V4 with frequency f4 of 10 Hz is applied as 1 (one).

As shown in FIG. 7B, ratio R₂ (=W₃/W₄) of spectral radiance W₃ at wavelength λa (=3.4 μm) to spectral radiance W₄ at wavelength λb (=4.0 μm) when frequency f4 is 10 Hz is about 1.81. Ratio R₂ (=W₃/W₄) of spectral radiance W₃ and spectral radiance W₄ when frequency f4 is 20 Hz is about 1.78.

At start-up of sensor 21, controller 22 changes frequency f4 of voltage V4 and compares ratio R₁ (=W₁/W₂) with ratio R₂ (=W₃/W₄), thereby determining a failure in light-receiving device 5. A difference between ratio R₁ and ratio R₂ at the change of frequency f4 of voltage V4 is detected so that a failure in light-receiving device 5 is determined. Similarly to sensor 1 according to Embodiment 1, sensor 21 can thus correctly determine a failure in light-receiving device 5.

Similarly to sensor 1 according to Embodiment 1, controller 22 of sensor 21 according to Embodiment 2 may also set frequency f4 at 10 Hz in period T11, change frequency f4 from 10 Hz to 20 Hz at time point t1, and change frequency f4 from 20 Hz to 10 Hz at time point t2 when period T12 (self-determination period T1) ends. Alternatively, controller 22 may set frequency f4 at 20 Hz in period T11 and change frequency f4 from 20 Hz to 10 Hz at time point t1. In any of both orders of the change of frequency f4 of voltage V4, a failure of light-receiving device 5 can be determined.

### Exemplary Embodiment 3

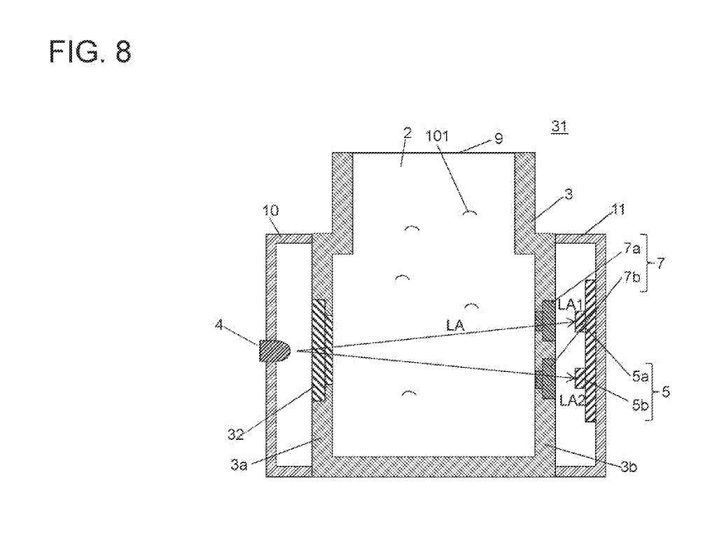

FIG. 8 is a side cross-sectional view of sensor 31 according to Exemplary Embodiment 3. In FIG. 8, components identical to those of sensors 1 and 21 according to Embodiments 1 and 2 illustrated in FIGS. 1 to 7B are denoted by the same reference numerals.

Body 3 of sensor 31 illustrated in FIG. 8 includes window 32, instead of window 6 of body 3 of sensors 1 and 21. Similarly to windows 6 of sensors 1 and 21, window 32 allows light LA emitted from light-emitting device 4 to pass through, and allows light LA to enter into internal space 2 of body 3. Similarly to sensors 1 and 21 according to Embodiments 1 and 2, at start-up of sensor 31, controller 8 (22) changes light LA from light-emitting device 4 to determine a failure of light-receiving device 5 (5a, 5b). Window 32 has surface 32a and surface 32b opposite to surface 32a. Surface 32a faces internal space 2. Surface 32b is opposed to light-emitting device 4. Light LA emitted from light-emitting device 4 passes through surfaces 32a and 32b of window 32, and enters into internal space 2. That is, light LA passes through surfaces 32a and 32b. Optical filter 7a has surface 7aa and surface 7ab opposite to surface 7aa. Surface 7aa faces internal space 2. Surface 7ab is opposed to light-receiving device 5a. Light LA that has passed through internal space 2 passes through surfaces 7aa and 7ab of optical filter 7a, and enters into light-receiving device 5a as light LA1. That is, light LA (LA1) passes through surfaces 7aa and 7ab. Optical filter 7b has surface 7ba and surface 7bb opposite to surface 7ba. Surface 7ba faces internal space 2. Surface 7bb is opposed to light-receiving device 5b. Light LA that has passed through internal space 2 passes through surfaces 7ba and 7bb of optical filter 7b, and enters into light-receiving device 5b as light LA2. That is, light LA (LA2) passes through surfaces 7ba and 7bb

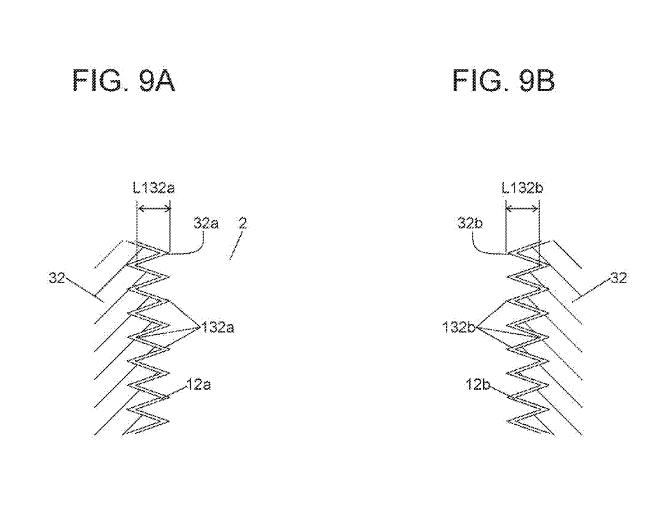

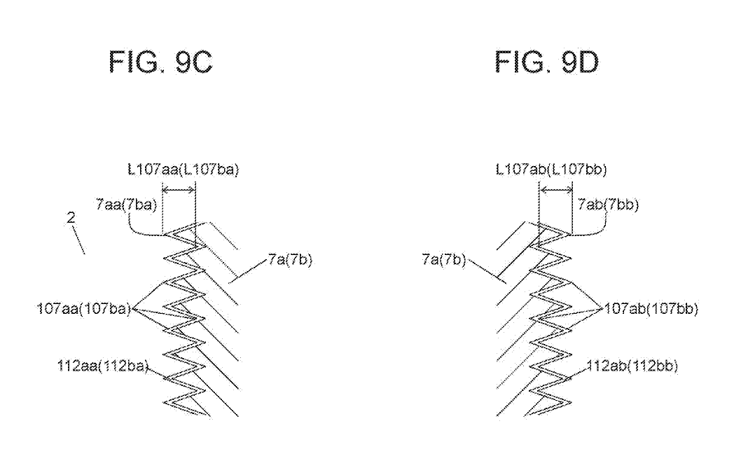

FIG. 9A is an enlarged cross-sectional view of window 32, and particularly illustrates the vicinity of surface 32a. Surface 32a of window 32 has minute asperities 132a provided therein.

Advantages of minute asperities 132a will be described below. In a case where fluid 101 as a detection object is gas, such as butane, having a low boiling point, dew condensation might occur under certain operating environments so that liquid droplets are unintentionally attached onto surface 32a of window 32. The number of molecules included per a unit volume is significantly different between gas state and liquid state. Therefore, when the liquid droplets are attached onto surface 32a of window 32, light LA is significantly absorbed by liquid droplets attached onto window 32. This situation significantly changes the intensity of light received by light-receiving device 5, and decreases the detection accuracy of sensor 31 accordingly.

In sensor 31, since surface 32a contacting internal space 2 of window 32 has minute asperities 132a provided therein as illustrated in FIG. 9A, minute asperities 132a remove liquid droplets attached onto surface 32a of window 32 from surface 32a due to the lotus effect. This configuration reduces such significant absorption of light LA in liquid droplets attached onto surface 32a of window 32, and enhances accuracy in detecting the concentration of fluid 101 as a detection object accordingly.

Minute asperities 132a have height L132a equal to or smaller than ¼ of the wavelength of light LA. This configuration decreases a part of light LA absorbed by minute asperities 34 while light LA passes through minute asperities 132a, thus providing the effect of removing liquid droplets without decreasing sensitivity of sensor 31.

Anti-reflection film 12a is provided on minute asperities 132a of surface 32a of window 32. Anti-reflection film 12a can prevent the amount of light reaching light-receiving device 5 from decreasing due to surface reflection caused by difference in refractive index among members constituting body 3, the air, and fluid 101 in internal space 2. As a result, a decrease in the sensitivity of sensor 31 can be prevented.

FIG. 9B is an enlarged cross-sectional view of window 32, and particularly illustrates the vicinity of surface 32b. Surface 32b of window 32 has minute asperities 132b provided therein. Minute asperities 132b have height L132b equal to height L132a of minute asperities 132a. Even when dew condensation is generated in space between body 3 and block 10 so that liquid droplets are attached, this configuration removes the liquid droplets from surface 32b of window 32 due to the lotus effect, and enhances sensitivity of sensor 31 accordingly. Window 32 may not necessarily have minute asperities 132a or 132b.

Anti-reflection film 12b is provided on minute asperities 132b of surface 32b of window 32. Anti-reflection film 12b can prevent the amount of light reaching light-receiving device 5 from decreasing due to surface reflection caused by a difference in refractive index between the air and each of members constituting body 3. As a result, a decrease in sensitivity of sensor 31 can be prevented. Sensor 31 may not necessarily include at least one of anti-reflection films 12a and 12b.

FIG. 9C is an enlarged cross-sectional view of optical filter 7a (7b), and particularly illustrates the vicinity of surface 7aa (7bb). Surface 7aa (7ba) of optical filter 7a (7b) has minute asperities 107aa (107ba) provided therein.

In sensor 31, since surface 7aa (7ba) contacting internal space 2 of optical filter 7a (7b) has minute asperities 107aa (107ba) as illustrated in FIG. 9C, minute asperities 107aa (107ba) removes liquid droplets attached onto surface 7aa (7ba) of optical filter 7a (7b) from surface 7aa (7ba) due to the lotus effect. This configuration thus reduces significant absorption of light LA in liquid droplets attached to surface 7aa (7ba) of optical filter 7a (7b), and enhances accuracy in detecting the concentration of fluid 101 as a detection object accordingly.

Minute asperities 107aa (107ba) have height L107aa (L107ba) equal to or smaller than ¼ of the wavelength of light LA. This configuration decreases a part of light LA absorbed by minute asperities 107aa while light LA passes through minute asperities 34, thus providing the effect of removing liquid droplets without decreasing the sensitivity of sensor 31.

Anti-reflection film 112aa (112ba) is provided on minute asperities 107aa (107ba) of surface 7aa (7ba) of optical filter 7a (7b). Anti-reflection film 112aa (112ba) can prevent the amount of light reaching light-receiving device 5 from decreasing due to surface reflection caused by a difference in refractive index among members constituting body 3, the air, and fluid 101 in internal space 2. As a result, a decrease in sensitivity of sensor 31 can be prevented.

FIG. 9D is an enlarged cross-sectional view of optical filter 7a (7b), and particularly illustrates the vicinity of surface 7ab (7bb). Surface 7ab (7bb) of optical filter 7a (7b) has minute asperities 107ab (107bb) provided therein. Minute asperities 107ab (107bb) have height L107ab (L107bb) equal to height L107aa (L107ba) of minute asperities 107aa (107ba). Even when dew condensation is generated in space between body 3 and block 11 so that liquid droplets are attached, this configuration removes the liquid droplets from surface 7ab (7bb) of optical filter 7a (7b) due to the lotus effect, thus enhancing sensitivity of sensor 31. Optical filter 7a (7b) may not necessarily have minute asperities 107aa (107ba) or 107ab (107bb).

Anti-reflection film 112ab (112bb) is provided on minute asperities 107ab (107bb) of surface 7ab (7bb) of optical filter 7a (7b). Anti-reflection film 112ab (112bb) can prevent the amount of light reaching light-receiving device 5 from decreasing due to surface reflection caused by a difference in refractive index between the air and each of members constituting body 3. As a result, a decrease in sensitivity of sensor 31 can be prevented. Sensor 31 may not necessarily include at least one of anti-reflection film 112aa (112ba) or 112ab (112bb).

In accordance with Embodiment 3, fluid 101 as a detection object is butane. However, the present invention is not limited to this example. Sensor 31 may be used in an environment where dew condensation is easily generated, such as an environment where fluid 101 is other hydrocarbons such as hexane or other gases having low melting points.

### Exemplary Embodiment 4

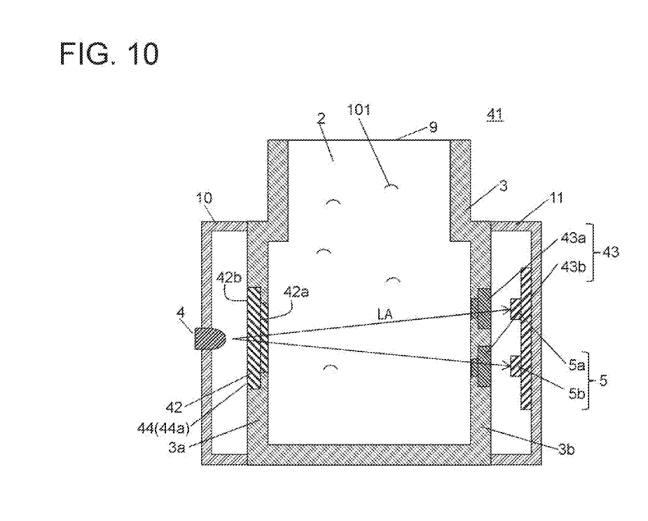

FIG. 10 is a side cross-sectional view of sensor 41 according to Exemplary Embodiment 4. In FIG. 10, components identical to those of sensors 1 and 21 according to Embodiments 1 and 2 illustrated in FIGS. 1 to 7B are denoted by the same reference numerals.

Sensor 41 illustrated in FIG. 10 includes optical filter 43 (43a, 43b), instead of optical filter 7 (7a, 7b) of sensors 1 and 21 according to Embodiments 1 and 2 illustrated in FIGS. 1 to 7B. Optical filter 43a allows only light having wavelength λa absorbed by fluid 101 as a detection object to pass through. Optical filter 43b does not allow light in light LA emitted from light-emitting device 4 having a wavelength absorbed by fluid 101 to pass through. Body 3 of sensor 31 includes window 42, instead of window 6 of body 3 of sensors 1 and 21. Similarly to windows 6 of sensors 1 and 21, window 42 allows light LA emitted from light-emitting device 4 to pass through, and allows light LA to enter into internal space 2 of body 3.

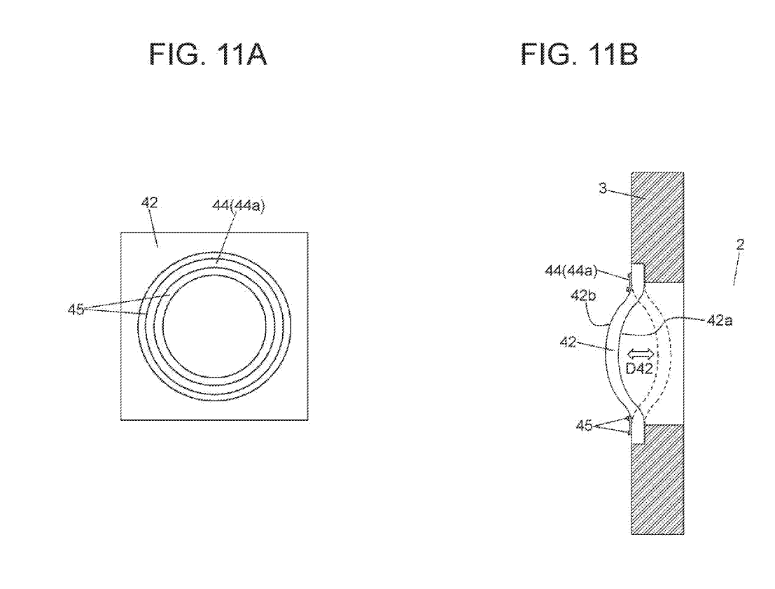

FIG. 11A is a front view of window 42. Piezoelectric film 44 as vibrator 44a for vibrating window 42 is disposed near the outer periphery of window 42. Piezoelectric film 44 is disposed away from the center of window 42. In sensor 41 according to Embodiment 4, window 42 has a circular shape, and piezoelectric film 44 has an annular ring shape having a space at the center of window 42. This configuration allows light LA to enter into internal space 2 even in a case where piezoelectric film 44 is made of material through which light does not easily pass. Electrode 45 is disposed around piezoelectric film 44. The controller applies a voltage having a predetermined frequency to piezoelectric film 44 to cause piezoelectric film 44 to vibrate due to a piezoelectric effect. FIG. 11B is a cross-sectional view of window 42, and illustrates vibrations of window 42. Piezoelectric film 44 is disposed on surface 42b of window 42 opposite to surface 42a contacting internal space 2. The voltage applied to electrode 45 by the controller causes window 42 to vibrate in direction D42 perpendicular to surface 42b, as illustrated in FIG. 11B. In a case where liquid droplets are attached onto window 42, this vibration of piezoelectric film 44 can remove the liquid droplets, and reduces a decrease in sensitivity of sensor 41 accordingly.

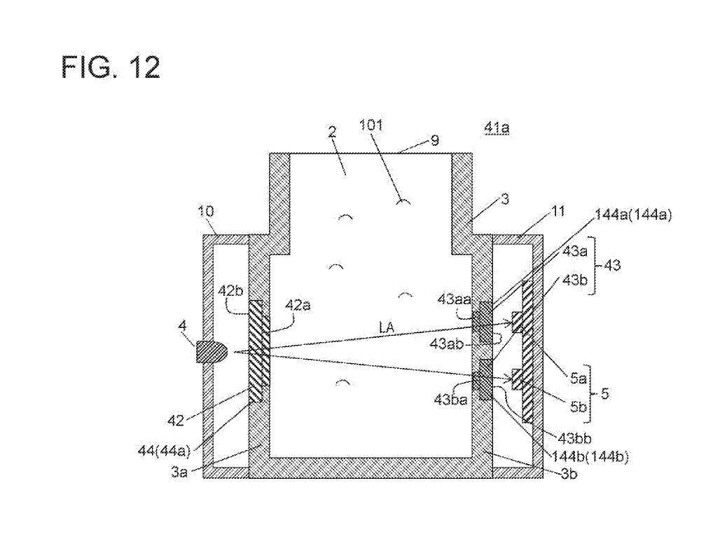

FIG. 12 is a side cross-sectional view of another sensor 41a according to Embodiment 4. In FIG. 12, components identical to those of sensor 41 illustrated in FIGS. 10 to 11B are denoted by the same reference numerals. In sensor 41a, as vibrator 44a disposed on window 42, piezoelectric films 144a and 144b and electrodes 145a and 145b similar to piezoelectric film 44 and electrode 45 are disposed on surfaces 43ab and 43bb opposite to surfaces 43aa and 43ba of optical filters 43a and 43b contacting internal space 2, respectively. Similarly to piezoelectric film 44, piezoelectric films 144a and 144b are disposed away from the centers of optical filters 43a and 43b, and have annular ring shapes as ring shapes surrounding the centers in according to Embodiment 4. Piezoelectric films 144a and 144b and electrodes 145a and 145b have advantages similar to those of piezoelectric film 44 and electrode 45. In sensor 41a, window 42 may not necessarily be provided with piezoelectric film 44 and electrode 45.

In accordance with Embodiment 4, piezoelectric films 44, 144a, and 144b have annular ring shapes that are ring shapes surrounding window 42 and optical filters 43a and 43b disposed away from the centers thereof. Piezoelectric films 44, 144a, and 144b have shapes allowing light LA to pass through the centers of window 42 and optical filters 43a and 43b. For example, instead of one piezoelectric film 44 having a ring shape surrounding the center of window 42, plural piezoelectric films having rectangular shapes may be disposed near the outer periphery of window 42. Instead of one piezoelectric film 144a having a ring shape surrounding the center of optical filter 43a, plural piezoelectric films having rectangular shapes may be disposed near the outer periphery of optical filter 43a. Instead of one piezoelectric film 144b having a ring shape surrounding the center of optical filter 43b, plural piezoelectric films having rectangular shapes may be disposed near the outer periphery of optical filter 43b.

### Exemplary Embodiment 5

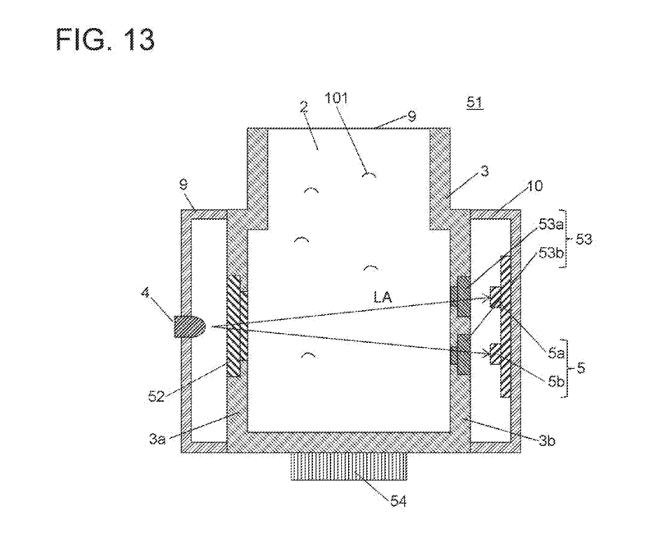

FIG. 13 is a side cross-sectional view of sensor 51 according to Exemplary Embodiment 5. In FIG. 13, components identical to those of sensors 1 and 21 according to Embodiments 1 and illustrated in FIGS. 1 to 7B are denoted by the same reference numerals.

As illustrated in FIG. 13, sensor 51 includes optical filter 53 (53a, 53b), instead of optical filter 7(7a, 7b) of sensors 1 and 21 according to Embodiments 1 and illustrated in FIGS. 1 to 7B, and further includes motor 54 disposed on the other side of body 3. Optical filter 53a allows only light having wavelength λa absorbed by fluid 101 as a detection object to pass through. Optical filter 53b does not allow light in light LA emitted from light-emitting device 4 having a wavelength absorbed by fluid 101 to pass through.

Motor 54 functions as a vibrator that vibrates body 3 at a particular frequency. This vibration removes liquid droplets attached to window 52 and optical filters 53a and 53b simultaneously, thereby preventing sensitivity of sensor 51 from decreasing. In addition, in sensor 31, since motor 54 as a vibrator is provided to body 3, it is not necessary to provide vibrators in any of window 52 and optical filters 53a and 53b. This configuration provides sensor 51 whose detection sensitivity does not easily degrade even in an environment where dew condensation is easily generated with a simple configuration.

### REFERENCE MARKS IN THE DRAWINGS

1, 21, 31, 41, 51 sensor
2 internal space
3 body
4 light-emitting device
5 light-receiving device
5a light-receiving device (first light-receiving device)
5b light-receiving device (second light-receiving device)
6, 32, 42, 52 window
7, 43, 53 optical filter
7a, 43a, 53a optical filter (first optical filter)
7b, 43b, 53b optical filter (second optical filter)
8, 22 controller
9 opening
44, 144 piezoelectric film
45, 145 electrode
54 motor
107aa, 107ba, 107ab, 107bb, 132a, 132b minute asperities

1. A sensor comprising:
a body having an internal space allowing fluid to flow into the internal space;
a light-emitting device configured to emit light passing through the internal space;
a first light-receiving device configured to receive the light that has passed through the internal space so as to provide a first output in accordance with an intensity of the received light;
a second light-receiving device configured to receive the light that has passed through the internal space so as to provide a second output in accordance with an intensity of the received light;
a first optical filter disposed between the first light-receiving device and the light-emitting device, the first optical filter allowing the light to pass through the first optical filter;
a second optical filter disposed between the second light-receiving device and the light-emitting device, the second optical filter allowing the light to pass through the second optical filter; and
a controller connected to the light-emitting device, the first light-receiving device, and the second light-receiving device,
wherein the controller is configured to:
change the light emitted from the light-emitting device; and
compare a first ratio between the first output and the second output before the changing of the light to a second ratio between the first output and the second output after the changing of the light.

2. (canceled)

3. A sensor comprising:
a body having an internal space allowing fluid to flow in the internal space;
a light-emitting device configured to emit light passing through the internal space;
a first light-receiving device configured to receive the light that has passed through the internal space so as to provide a first output in accordance with an intensity of the received light;
a second light-receiving device configured to receive the light that has passed through the internal space so as to provide a second output in accordance with an intensity of the received light;
a first optical filter disposed between the first light-receiving device and the light-emitting device, the first optical filter allowing the light to pass through the first optical filter;
a second optical filter disposed between the second light-receiving device and the light-emitting device, the second optical filter allowing the light to pass through the second optical filter; and
a controller connected to the light-emitting device, the first light-receiving device, and the second light-receiving device,
wherein the controller is configured to change the light emitted from the light-emitting device when the sensor starts up.

4. The sensor of claim 3,
wherein the first optical filter allows only light having a wavelength to be absorbed by the fluid to pass through the first optical filter, and
wherein the second optical filter does not allow light having the wavelength to be absorbed by the fluid to pass through the second optical filter.

5. The sensor of claim 4, wherein the second optical filter allows only light having a wavelength not to be absorbed by the fluid to pass through the second optical filter.

6. The sensor of claim 3, wherein the controller is configured to change the light emitted from the light-emitting device by changing a voltage applied to the light-emitting device.

7. (canceled)

8. (canceled)

9. The sensor of claim 3, wherein the controller is configured to change the light emitted from the light-emitting device by changing a frequency of a voltage applied to the light-emitting device.

10. (canceled)

11. (canceled)

12. The sensor of claim 3,
wherein the first optical filter has a first surface having first minute asperities therein allowing the light to pass through the first surface, and
wherein the second optical filter has a second surface having second minute asperities therein allowing the light to pass through the second surface.

13. (canceled)

14. (canceled)

15. The sensor of claim 3,
wherein the body further includes a window allowing the light emitted from the light-emitting device to enter in the window, and
wherein the window has a surface having minute asperities allowing the light to pass through the surface.

16. (canceled)

17. (canceled)

18. The sensor of claim 3, further comprising a vibrator configured to remove liquid droplets produced in the internal space.

19. (canceled)

20. (canceled)

21. The sensor of claim 18, wherein the vibrator includes a motor disposed outside the body.

22. The sensor of claim 3, wherein the controller detects a concentration of the fluid based on the first output and the second output.

23. The sensor of claim 1,
wherein the first optical filter allows only light having a wavelength to be absorbed by the fluid to pass through the first optical filter, and
wherein the second optical filter does not allow light having the wavelength to be absorbed by the fluid to pass through the second optical filter.

24. The sensor of claim 23, wherein the second optical filter allows only light having a wavelength not to be absorbed by the fluid to pass through the second optical filter.

25. The sensor of claim 1, wherein the controller is configured to change the light emitted from the light-emitting device by changing a voltage applied to the light-emitting device.

26. The sensor of claim 1, wherein the controller is configured to change the light emitted from the light-emitting device by changing a frequency of a voltage applied to the light-emitting device.

27. The sensor of claim 1,
wherein the first optical filter has a first surface having first minute asperities therein allowing the light to pass through the first surface, and
wherein the second optical filter has a second surface having second minute asperities therein allowing the light to pass through the second surface.

28. The sensor of claim 1,
wherein the body further includes a window allowing the light emitted from the light-emitting device to enter in the window, and
wherein the window has a surface having minute asperities allowing the light to pass through the surface.

29. The sensor of claim 1, further comprising a vibrator configured to remove liquid droplets produced in the internal space.

30. The sensor of claim 29, wherein the vibrator includes a motor disposed outside the body.

31. The sensor of claim 1, wherein the controller detects a concentration of the fluid based on the first output and the second output.
